(19) United States
(12) Patent Application Publication
(10) Pub. No.: US 2024/0296979 A1
(43) Pub. Date: Sep. 5, 2024

(54) Surge Protection Device

(71) Applicant: CITEL, PARIS (FR)

(72) Inventors: Kim MOUTON, MARCQ (FR); Vincent MATHIEU, CHATILLON (FR); Maëlle AUTRIQUE, BERNAY (FR)

(21) Appl. No.: 18/436,375

(22) Filed: Feb. 8, 2024

(30) Foreign Application Priority Data
Feb. 16, 2023 (FR) 2301469

(51) Int. Cl. H01C 7/12; H01H 37/76

(52) U.S. Cl. CPC H01C 7/126; H01H 37/761

(57) ABSTRACT

A surge protection device has a first connection terminal and a second connection terminal. A first set of protection components having a first varistor and a gas discharge tube are connected to each other by a thermofusible connection with a first arc-breaking device having an insulating flap configured to move when the thermofusible connection changes from a connected state to a disconnected state. The first set of protection components has a flexible braid that is welded to the gas discharge tube and electrically connected to a connection piece that is electrically connected to the second connection terminal that has a flexible braid and capable of being deforming in order to allow the gas discharge tube to move away from the first varistor.

### CROSS REFERENCE TO RELATED APPLICATION

This patent application claims the benefit and priority of French Patent Application No. 2301469, filed on Feb. 16, 2023, the disclosure of which is incorporated by reference herein in its entirety as part of the present disclosure.

### FIELD

The invention relates to the field of surge protection devices.

### BACKGROUND

Patent application EP3244504 discloses a surge protection device comprising a varistor, a gas discharge tube and a thermofusible soldering fixing an electrode of the varistor to a first electrode of the gas discharge tube. In addition, the second electrode of the gas discharge tube is soldered to a resilient blade by means of which the gas discharge tube is electrically connected to a connection terminal. The resilient blade is able to move between a connection position and a disconnection position in which the gas discharge tube is moved away from the varistor and is pre-stressed so as to exert a bias force towards the disconnection position. The protection device also includes an insulating flap which is movably mounted. In the event of a surge, the varistor heats up, causing the temperature of the thermofusible connection to rise. When the thermofusible connection is heated above its melting point, it melts and no longer fixes the gas discharge tube to the varistor. The resilient blade is then biased towards its disconnection position so as to move the gas discharge tube away from the varistor, thereby disconnecting the protection device. The insulating flap can then be inserted between the gas discharge tube and the varistor to prevent arcing.

Such a protection device is not fully satisfactory. In particular, in order to obtain a stiffness of the resilient strip that is low enough to allow the gas discharge tube to move away from the varistor when the thermofusible soldering melts, the conductive cross-section of the resilient strip is limited. Limiting the conductive cross-section of the resilient strip leads to restrictions on the maximum currents that can flow through the surge protection device.

### SUMMARY

The idea underlying the invention is to offer a surge protection device that is simple, reliably ensures total disconnection at the end of component life and has a structure that allows high currents to pass through the surge protection device.

According to one embodiment, the invention provides a surge protection device comprising:
at least a first connection terminal and a second connection terminal which are respectively intended to be connected to a first line and a second line of an electrical installation to be protected;
a first set of protection components comprising at least a first varistor and a gas discharge tube, the first varistor comprising a first varistor electrode and a second varistor electrode, the first varistor electrode being electrically connected to the first connection terminal, the gas discharge tube comprising a first discharge tube electrode and a second discharge tube electrode; the first discharge tube electrode being electrically connected to the second varistor electrode by a thermofusible connection which is capable of changing, when said thermofusible connection is subjected to a temperature exceeding a threshold, from a connected state to a disconnected state in which the second varistor electrode and the first discharge tube electrode are disconnected from each other;
at least a first arc-breaking device which comprises an insulating flap which is configured to move, when the thermofusible connection passes from the connected state to the disconnected state, from an original position to a cut-off position in which said insulating flap is interposed between the second varistor electrode and the first discharge tube electrode;
   said protection device being noteworthy in that the first set of protection components comprises a flexible braid which is welded to the second discharge tube electrode and is electrically connected to a connection piece, said connection piece being electrically connected to the second connection terminal, said flexible braid being able to deform so as to allow the gas discharge tube to move away from the first varistor and the insulating flap to move into the cut-off position when the thermofusible connection passes into the disconnected state.

Such a flexible braid is particularly advantageous in that it offers an excellent compromise between a large cross-section allowing high currents to be transmitted and a low stiffness allowing movement of the gas discharge tube relative to the first varistor when the thermofusible connection has melted.

According to embodiments, such a protection device may have one or more of the following features.

In one embodiment, the thermofusible connection comprises a thermofusible soldering.

In one embodiment, the thermofusible soldering is made from a tin alloy.

In one embodiment, the flexible braid has a cross-section of between 2 and 14 mm². According to an advantageous embodiment, the flexible braid has a cross-section of between 4 and 12 mm², and for example of the order of 8 mm².

In one embodiment, the flexible braid comprises a plurality of copper strands braided together.

In one embodiment, each copper strand has a diameter of between 0.01 and 0.10 mm, for example in the order of 0.05 mm.

According to an embodiment, the first arc-breaking device comprises at least one resilient member which is arranged to bias the insulating flap towards the cut-off position and which holds a first end of the insulating flap in abutment against the gas discharge tube when said insulating flap is in the original position.

In one embodiment, at least part of the first end comprises a bevel with a thickness that increases towards a second, opposite end of the insulating flap.

In one embodiment, the protection device comprises a remote signalling module that is pre-assembled and positioned in a dedicated housing, the remote signalling module comprising a connector suitable and intended for connection to a remote monitoring station and a switch that is electrically connected to said connector.

According to an embodiment, the switch comprises a blade which is arranged opposite the insulating flap in such a way that the blade of the switch moves from an open state to a closed state when the insulating flap moves from the original position to the cut-off position.

According to one embodiment, the first set of protection components further comprises a second varistor which is arranged electrically in parallel with the first varistor, between the first connection terminal and the gas discharge tube, the second varistor comprising a first varistor electrode and a second varistor electrode, the first varistor and the second varistor being arranged in planes parallel to one another, the second varistor electrode of the first varistor and the second varistor electrode of the second varistor having bent portions which extend perpendicularly to the planes of the first and second varistors, project towards one another and are soldered to one another in an overlap region.

In one embodiment, the first varistor electrode of the first varistor and the first varistor electrode of the second varistor are formed in one piece.

According to one embodiment, the protection device further comprises a visual indication device which includes an indicator screen configured to take up a position representative of the position of the insulating flap of the first arc-breaking device, said indicator screen being movable between a first position representative of an in-service state of the protection device corresponding to the original position of the insulating flap and a second position representative of an out-of-service state of the protection device corresponding to the cut-off position of the insulating flap.

According to one embodiment, the indicator screen can move in translation in a direction that is perpendicular to a direction of movement of the insulating flap between the original position and the cut-off position, the visual indication device comprising a resilient member configured to bias the indicator screen towards the second position, the indicator screen comprising a locking member arranged to cooperate with a complementary locking member which is kinematically connected to the insulating flap, when the indicator screen is in the second position and the insulating flap is in the original position, so that a movement of the insulating flap from the original position towards the cut-off position causes a release of the locking member and a movement of the indicator screen towards the second position.

In one embodiment, the indicator screen locking member is a hook and the complementary locking member is an insulating flap locking pin.

According to one embodiment, the protection device comprises a housing comprising a base and a cover defining between them an internal space in which there are housed the first connection terminal, the second connection terminal, the first varistor, the gas discharge tube, the thermofusible connection, the flexible braid, the connection piece and the first arc-breaking device, the cover comprising a lid which is removable, the indicator screen being mounted so as to be translationally movable on said lid. In this way, the visual indication device can be pre-assembled on the lid.

In one embodiment, the lid comprises a window through which the display screen is visible when said display screen is in the second position.

In one embodiment, the indicator screen comprises a member which is suitable and intended for receiving a tool and which is arranged opposite an aperture which is formed in the lid and which extends parallel to the direction of movement of the indicator screen. This enables the visual indication device to be fitted from outside the housing.

According to an embodiment, the protection device comprises a third connection terminal and a second set of protection components comprising at least a varistor and a gas discharge tube which are arranged in series between the third connection terminal and the connection piece and are connected to each other by a second thermofusible connection, the protection device further comprising a second arc-breaking device which includes an insulating flap which is configured to move, when the second thermofusible connection passes from a connected state to a disconnected state, from an original position to a cut-off position in which said insulating flap is interposed between the varistor and the gas discharge tube of the second set of protection components.

According to one embodiment, the protection device also comprises a visual indication device which includes an indicator screen, said indicator screen being movable between a first position representative of an in-service state of the protection device corresponding to the original position of the insulating flap of the first and second arc-breaking devices and a second position representative of an out-of-service state of the protection device corresponding to the cut-off position of the insulating flap of at least one of the first and second arc-breaking devices. This makes it possible to share the visual indication device for several sets of protection components.

According to an embodiment, the indicator screen is translationally movable in a direction that is perpendicular to the directions of movement of the insulating flap of the first and second arc-breaking devices between the original position and the cut-off position, the visual indication device comprising a resilient member configured to bias the indicator screen towards the second position, the indicator screen comprising a locking member arranged to cooperate with a complementary locking member of a locking device when the indicator screen is in the second position and said locking device is in a locking position, said locking device being movable between the locking position and an unlocked position and being kinematically connected to the insulating flaps of the first and second arc-breaking devices so that a movement of the insulating flap of at least one of the first and second arc-breaking devices towards the cut-off position causes a movement of the locking device towards the unlocked position and, consequently, a release of the locking member and a movement of the indicator screen towards the second position.

In one embodiment, the locking device comprises a shaft pivotally mounted between a locking position and an unlocked position, the shaft comprising at least two actuating fingers which are respectively arranged to be moved by the insulating flap of one and the other of the first and second arc-breaking devices when the shaft is in the locking position and said insulating flap moves from the original position to the cut-off position in order to rotate the shaft towards the unlocked position.

According to a second aspect, the invention relates to a method for assembling a protection device comprising:
making a first sub-assembly comprising:
   at least a first connection terminal and a second connection terminal which are respectively intended to be connected to a first line and to a second line of an electrical installation to be protected;
   a first set of protection components comprising at least a first varistor and a gas discharge tube, the first varistor comprising a first varistor electrode and a second varistor electrode, the first varistor electrode being electrically connected to the first connection terminal, the gas discharge tube comprising a first discharge tube electrode and a second discharge tube electrode; the first discharge tube electrode being electrically connected to the second varistor electrode by a thermofusible connection which is capable of changing, when said thermofusible connection is subjected to a temperature exceeding a threshold, from a connected state to a disconnected state in which the second varistor electrode and the first discharge tube electrode are disconnected from each other; the first protection component assembly comprising a flexible braid which is welded to the second discharge tube electrode and electrically connected to a connection piece, said connection piece being electrically connected to the second connection terminal, said flexible braid being able to deform in order to allow the gas discharge tube to move away from the first varistor and the insulating flap to move into the cut-off position when passing from the thermofusible connection to the disconnected state;
mounting the first sub-assembly in a base of a housing;
mounting a first arc-breaking device in the housing, the first arc-breaking device comprising an insulating flap which is configured to move, upon a transition of the thermofusible connection from the connected state to the disconnected state, from an original position to a cut-off position in which said insulating flap is interposed between the second varistor electrode and the first discharge tube electrode; and
closing the housing by securing the socket to a cover of the housing.

Such an assembly process is advantageous in that it avoids subjecting the housing to the high temperatures likely to be reached when making the thermofusible connection.

According to a third aspect, the invention relates to a surge protection device comprising:
a first protection element, for example a varistor, and a second protection element, for example a gas discharge tube, which are connected to each other by a thermofusible connection which is able to change, when said thermofusible connection is subjected to a temperature exceeding a threshold, from a connected state to a disconnected state in which the first protection element and the second protection element are disconnected from each other;
at least a first arc-breaking device comprising an insulating flap which is configured to move, when the thermofusible connection passes from the connected state to the disconnected state, from an original position to a cut-off position in which said insulating flap is interposed between the first protection element and the second protection element; and
a remote signalling module which is pre-assembled and positioned in a dedicated housing, the remote signalling module comprising a connector adapted and intended to be connected to a remote monitoring station and a switch which is electrically connected to said connector, the switch comprising a blade which is disposed opposite the insulating flap in such a way that the blade of the switch moves from an open state to a closed state when the insulating flap moves from the original position to the cut-off position.

This means that all the functions of the remote signalling module are pre-assembled, making it easier to manufacture and assemble the surge protection device.

This third aspect of the invention may comprise one or more of the features mentioned under the first aspect of the invention.

According to a fourth aspect, the invention also provides a sub-assembly for a surge protection device, the sub-assembly comprising a first varistor and a second varistor, the first varistor and the second varistor being disposed against each other and in planes parallel to each other, the sub-assembly having an electrode common to the first varistor and the second varistor which is disposed between them, the first varistor and the second varistor each having a second varistor electrode on a side of the first and second varistors opposite the other, the second varistor electrode of the first varistor and the second varistor electrode of the second varistor having bent portions which extend perpendicularly to the planes of the first and second varistors, project towards one another and are welded to one another in an overlap region.

Such a sub-assembly is particularly compact. In addition, the structure of the second varistor electrodes means that they can be standardized for use with varistors of different thicknesses.

This fourth aspect of the invention may comprise one or more of the features mentioned in conjunction with the first aspect of the invention.

According to a fifth aspect, the invention relates to a surge protection device comprising:
a first protection element, for example a varistor, and a second protection element, for example a gas discharge tube, which are connected to each other by a thermofusible connection which is able to change, when said thermofusible connection is subjected to a temperature exceeding a threshold, from a connected state to a disconnected state in which the first protection element and the second protection element are disconnected from each other,
at least a first arc-breaking device comprising an insulating flap which is configured to move, when the thermofusible connection passes from the connected state to the disconnected state, from an original position to a cut-off position in which said insulating flap is interposed between the first protection element and the second protection element;
   the protection device further comprises a visual indication device which includes an indicator screen configured to take up a position representative of the position of the insulating flap of the first arc-breaking device, said indicator screen being movable between a first position representative of an in-service state of the protection device corresponding to the original position of the insulating flap and a second position representative of an out-of-service state of the protection device corresponding to the cut-off position of the insulating flap, the indicator screen being movable in translation in a second direction, perpendicular to a direction of movement of the insulating flap between the original position and the cut-off position, the visual indication device comprising a resilient member configured to bias the indicator screen towards the second position, the indicator screen comprising a locking member arranged to cooperate with a complementary locking member which is kinematically connected to the insulating flap, when the indicator screen is in the second position and the insulating flap is in the original position, so that a movement of the insulating flap from the original position towards the cut-off position leads to a release of the locking member and a movement of the indicator screen towards the second position.

This fifth aspect of the invention may comprise one or more of the features mentioned under the first aspect of the invention.

According to a sixth aspect, the invention relates to a surge protection device comprising:
a first protection element, for example a varistor, and a second protection element, for example a gas discharge tube, which are connected to each other by a thermofusible connection which is able to change, when said thermofusible connection is subjected to a temperature exceeding a threshold, from a connected state to a disconnected state in which the first protection element and the second protection element are disconnected from each other
at least a first arc-breaking device comprising an insulating flap which is configured to move, when the thermofusible connection passes from the connected state to the disconnected state, from an original position to a cut-off position in which said insulating flap is interposed between the first protection element and the second protection element; the first arc-breaking device comprising at least one resilient member which is arranged to bias the insulating flap towards the cut-off position and which holds a first end of the insulating flap in abutment against the second protection component when said insulating flap is in the original position and wherein at least part of the first end comprises a bevel having a thickness which increases towards a second, opposite end of the insulating flap.

Such a bevel makes it easier for the insulating flap to pass between the first and second protection elements.

This sixth aspect of the invention may comprise one or more of the features mentioned under the first aspect of the invention.

### BRIEF DESCRIPTION OF THE FIGURES

The invention will be better understood, and other purposes, details, features and advantages thereof will become clearer in the course of the following description of several particular embodiments of the invention, given by way of illustration only and not by way of limitation, with reference to the appended drawings.

FIG. 1 is a schematic representation of an electrical circuit of a surge protection device, according to a first embodiment, intended for a single-phase installation.

FIG. 2 is a perspective view of a housing of a protection device according to the first embodiment.

FIG. 3 is a perspective view of the electrical circuit of the protection device according to the first embodiment.

FIG. 4 is a bottom view of the varistors of the protection device in the first embodiment.

FIG. 5 is another perspective view of the electrical circuit of the protection device according to the first embodiment.

FIG. 6 is another perspective view of the electrical circuit of the protection device in the first embodiment.

FIG. 7 is a partial perspective view of the protection device according to the first embodiment, showing in particular the features of the arc-breaking device.

FIG. 8 is another partial perspective view of the protection device according to the first embodiment, showing in particular the features of the arc-breaking device and the visual indication device.

FIG. 9 is another partial perspective view, similar to FIG. 7, in which the housing base is shown.

FIG. 10 is a partial side view of the protection device in the first embodiment, showing in particular the features of the insulating flap of the arc-breaking device.

FIG. 11 is a partial top view of the protection device according to the first embodiment, showing in particular the features of the housing lid.

FIG. 12 is a perspective view illustrating the remote signalling module of the protection device according to the first embodiment.

FIG. 13 is a schematic representation of an electrical circuit of a surge protection device, according to a second embodiment, intended for a three-phase installation.

FIG. 14 is a partial top view of the protection device according to the second embodiment.

FIG. 15 is a partial side view of the protection device according to the second embodiment, showing in particular the features of the device for unlocking the visual indication device.

FIG. 16 is a partial perspective view of the protection device according to the second embodiment, showing in particular the features of the device for unlocking the visual indication device.

FIG. 17 is a schematic representation of an electrical circuit of a surge protection device, according to a third embodiment, intended for a single-phase installation.

FIG. 18 is a schematic representation of an electrical circuit of a surge protection device, according to a fourth embodiment, intended for a three-phase installation.

FIG. 19 is a schematic representation of an electrical circuit of a surge protection device, according to a fifth embodiment, intended for a three-phase installation.

### DETAILED DESCRIPTION

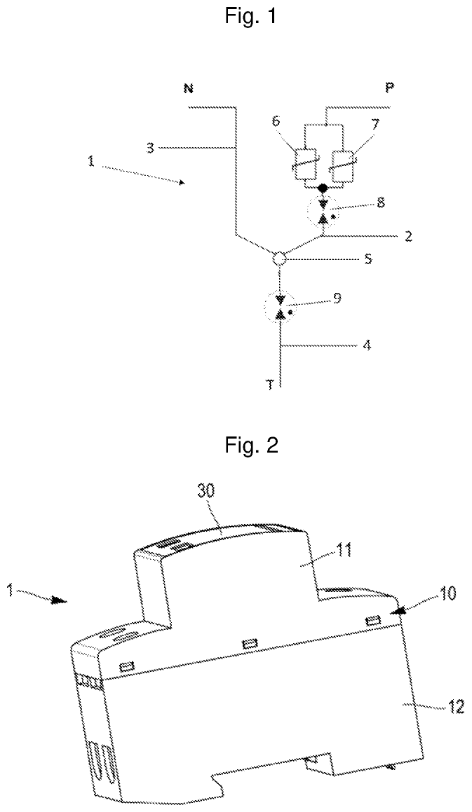

FIG. 1 is a schematic illustration of an electrical circuit for a surge protection device 1. The protection device 1 is intended to be installed in an electrical installation in parallel and upstream of the equipment to be protected. In this figure, the electrical installation is a single-phase installation and therefore comprises a phase line P, a neutral line N and an earth line T. The circuit of the protection device 1 comprises three branches, namely a phase branch 2, a neutral branch 3 and an earth branch 4, each of which is intended to be connected to one of the three aforementioned lines. The three branches 2, 3 and 4 meet at a central connection point 5. Such an electrical circuit therefore has a so-called Y configuration. The phase branch 2 and the earth branch 4 each have one or more protection elements 6, 7, 8, 9. A protection device 1 of this type therefore eliminates surges: in common mode, between phase or neutral and earth; and in differential mode, between phase and neutral. When the protection elements are subjected to a voltage lower than their activation voltage, they act as high-impedance elements so that no current flows through them. On the other hand, when they are subjected to a voltage higher than their activation voltage, they act as elements of almost zero impedance, so that the voltage is shunted.

In the embodiment shown, the phase branch 2 has three protection elements, namely two varistors 6, 7 arranged in parallel and a gas discharge tube 8. The gas discharge tube 8 is advantageous in that it has no leakage current until it is triggered, whereas the varistors 6, 7 have a leakage current in the order of a few tens or hundreds of microamperes, which causes them to age prematurely. However, the gas discharge tube 8 has the disadvantage of only being able to switch off when the so-called follow current flowing through it is sufficiently low, so that it is not impossible for a gas discharge tube 8 to remain triggered when it is not coupled with a varistor. Thus, the combination of one or more varistors 6, 7 with a gas discharge tube 8 is particularly advantageous in that it makes it possible to limit the leakage current while reliably ensuring a return to a high-impedance state after the overvoltage has passed. It should be noted that, although in the embodiments shown, the phase branch comprises two varistors 6, 7, it may also comprise only one or more than two.

The earth branch 4, on the other hand, only has a gas discharge tube 9, since in this arrangement there is no risk of the gas discharge tube 9 remaining ignited after the surge has passed.

In relation to FIGS. 2 to 12, a protection device 1 is described below according to an embodiment corresponding to the electrical circuit in FIG. 1.

In relation to FIG. 2, it can be seen that the protection device 1 comprises a housing 10 comprising a base 11 and a cover 12 defining between them an internal space in which the components of the protection device are housed. The housing 10 is made of plastic, for example. The base 11 is designed to be fixed to a fixing rail, not shown. The base 11 and the cover 12 are clipped together, for example.

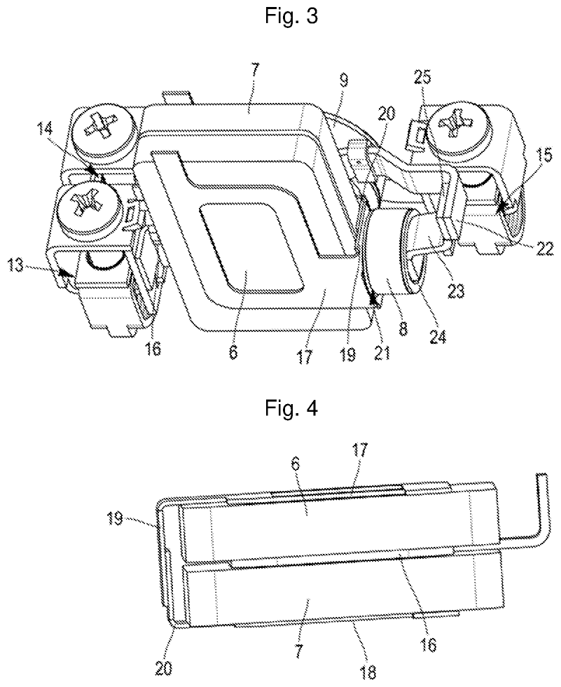

The electrical circuit of the protection device and its components are illustrated in FIG. 3. The protection device comprises a first, a second and a third connection terminal 13, 14, 15 which are respectively intended to be electrically connected to the phase line, the neutral line and the earth line. The first connection terminal 13 is intended to be electrically connected to the varistors 6, 7 and more particularly to a part forming an electrode 16 common to both varistors 6, 7, in the embodiment shown. The varistors 6, 7 are substantially in the shape of a flattened rectangular parallelepiped. Each varistor 6, 7 thus has two large rectangular faces that are parallel to each other. The two varistors 6, 7 are arranged geometrically parallel to each other. As the varistors are positioned against each other, the electrode 16, visible in FIG. 4, is common to both varistors 6, 7 and is positioned between them. Furthermore, as also shown in FIG. 4, the large faces of the varistors 6, 7 which are opposite each other are each equipped with an electrode 17, 18. The electrodes 17, 18 are connected to each other. To do this, said electrodes 17, 18 have bent portions 19, 20. The bent portions 19, 20 extend perpendicular to the large faces of the varistors 6, 7 and project towards each other. One of the bent portions 19, 20 overlaps the other and the bent portions 19, 20 are welded together in the overlap area. Thanks to the size of this overlap area between the bent portions 19, 20, the electrodes 17, 18 can be used to electrically connect varistors of different thicknesses.

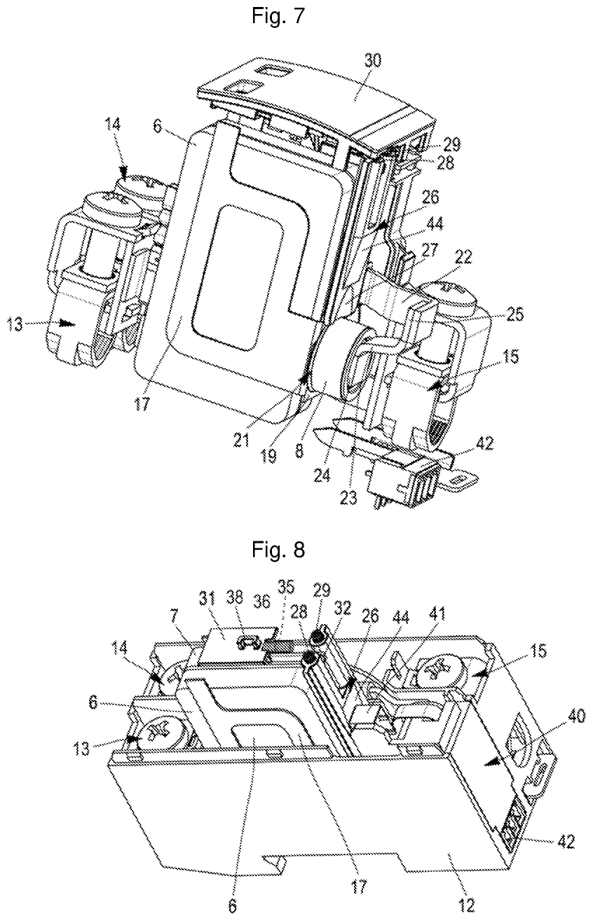

In addition, one of the electrodes of the gas discharge tube 8 is fixed to the bent part 19 of one of the two electrodes 17, 18 by a thermofusible connection 21. This thermofusible connection 21 is made by any means and, for example, by a thermofusible soldering. The thermofusible soldering is made from a tin alloy, for example. In addition, the other electrode of the gas discharge tube 8 is electrically connected to a connection part a by means of a flexible braid 23, particularly visible in FIGS. 3 and 7.

The flexible braid 23 is advantageously made of copper. It comprises a plurality of copper strands braided together. According to an advantageous embodiment, the flexible braid 23 has a cross-section of between 2 and 14 mm², preferably between 4 and 12 mm², and for example in the order of 8 mm². In addition, each copper strand has a diameter of between 0.01 and 0.10 mm, for example in the order of 0.05 mm. In addition, each of the two ends of the flexible braid 23 is arranged in the form of a compacted zone 24, 25 which is welded or soldered to one of the electrodes of the gas discharge tube 8 or to the connection piece 22. According to one exemplary embodiment, the compacted areas 24, 25 have a contact surface advantageously greater than the cross-section of the flexible braid 23 and which is, for example, in the order of 6 mm by 6 mm.

In the event of a surge between phase and earth or phase and neutral, the varistors 6, 7 heat up, causing the temperature of the thermofusible connection 21 to rise. When the thermofusible connection 21 is heated above its melting point, it melts and no longer secures the gas discharge tube 8 to one of the electrodes 17, 18 of the varistors 6, 7. The flexible braid 23 is then likely to deform so that the gas discharge tube 8 moves away from the varistors 6, 7 and the latter are no longer electrically connected to the neutral N and earth T lines.

The use of such a flexible braid 23 is particularly advantageous in that, compared with other conductive elements, such as conductive blades, it offers a lower stiffness for the same conductive section. A flexible braid 23 of this type can therefore have a sufficiently large cross-section to allow high currents to be passed through it, while at the same time having a sufficiently low stiffness to allow the gas discharge tube 8 to move relative to the varistors 6, 7 in the event of melting of the thermofusible connection 21.

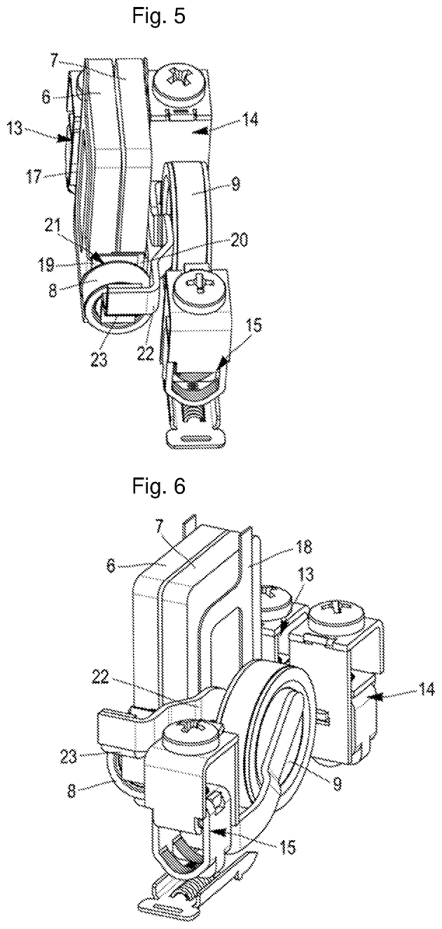

The connection piece 22, which is fully visible in FIG. 5, constitutes the central connection point. It electrically connects the flexible braid 23, on the one hand, to one electrode of the gas discharge tube 9 of the earth branch 4, and, on the other hand, to the second connection terminal 14, that is to say the one intended to be connected to the neutral line. Furthermore, as shown in FIG. 6, the other electrode of the gas discharge tube 9 of the earth branch 4 is electrically connected to the third connection terminal 15, that is to say the one intended for connection to the earth line. In the embodiment shown, the gas discharge tube 9 of the earth branch 4 is arranged so that its two electrodes are parallel to those of the varistors 6, 7, which makes it possible to give the protection device 1 excellent compactness.

In relation to FIGS. 7 to 9, it can be seen that the protection device 1 has an arc-breaking device. The arc-breaking device has an insulating flap 26. The insulating flap 26 is movably mounted inside the housing 10 between an original position, illustrated in FIGS. 7 to 9, and a cut-off position, not illustrated, in which the insulating flap 26 is positioned between the varistors 6, 7 and the gas discharge tube 8. The insulating flap 26 is guided, for example, in slides, not shown, in the housing 10. In addition, the arc-breaking device comprises at least one resilient member which is arranged to bias said insulating flap 26 towards the cut-off position. In the embodiment shown, the arc-breaking device comprises two helical springs 28, 29 which are stressed in compression and which each have one end bearing against a wall of the housing 10 and one end bearing against the insulating flap 26. In the embodiment shown, the helical springs 28, 29 have one end bearing against a lid 30 which is removably fixed to the cover 11. Such a lid 30 is, for example, clipped to the cover 11 of the housing 10. In addition, according to an advantageous embodiment, the helical springs 28, 29 are partly housed in housings formed in the insulating flap 26 and are threaded around centring pins, which are not visible, projecting from the lid 30, which prevents the helical springs 28, 29 from becoming misaligned.

As illustrated in FIGS. 7 to 9, as long as the thermofusible connection 21 is in the connected state, one end of the insulating flap 26 is in abutment against the gas discharge tube 8, which maintains said insulating flap 26 in the original position. When the thermofusible connection 21 has melted, the gas discharge tube 8 moves away from the varistors 6, 7, which allows the insulating flap 26 to be inserted between the varistors 6, 7 and the gas discharge tube 8, and thus to move into the cut-off position, thus preventing the formation of an electric arc between the varistors 6, 7 and the gas discharge tube 8.

According to an advantageous embodiment, at least part of the end of the insulating flap 26 which is in abutment against the gas discharge tube 8 when the thermofusible connection 21 is in the connected state has a bevel 27, particularly visible in FIG. 10. In other words, at least part of the end of the insulating flap 26, which is in abutment against the gas discharge tube 8 when the thermofusible connection 21 is in the connected state, has a thickness which increases towards the other end. This makes it easier to insert the insulating flap 26 between the gas discharge tube 8 and the varistors 6, 7. In addition, the insulating flap 26 has the effect of contributing to the movement of the gas discharge tube 8 away from the varistors 6, 7.

In addition, the protection device 1 has a visual indication device which comprises an indicator screen 31 configured to take up a position representative of the position of the insulating flap 26 of the arc-breaking device and, consequently, of the connected or disconnected state of the thermofusible connection 21. The indicator screen 31 is movable between a first position—representative of an in-service state of the protection device 1 corresponding to an original position of the insulating flap 26 and a connected state of the thermofusible connection 21—and a second position—representative of an out-of-service state of the protection device corresponding to a cut-off position of the insulating flap 26 and to a disconnected state of the thermofusible connection 21.

To do this, the indicator screen 31 is guided in translation on the lid 30, for example by means of slides, in a direction perpendicular to the direction of movement of the insulating flap 26 between the original position and the cut-off position. The indicator screen 31 comprises a locking member which is arranged to cooperate with a complementary locking member of the insulating flap 26 so as to lock the indicator screen 31 in the first position representative of an in-service state of the protection device 1, when said insulating flap 26 is in the original position. In the embodiment shown, the locking member is a hook 32 which is able to cooperate, when said insulating flap 26 is in the original position, with a locking pin 33, visible in FIG. 10, integral with the insulating flap 26. As shown in FIG. 10, the insulating flap 26 has a groove 34 through which the hook 32 passes when the insulating flap 26 is in the original position and the indicator screen 31 is in the first position. The locking pin 33 extends transversely inside said groove 34.

In addition, the visual indication device comprises at least one resilient member which is arranged to bias the indicator screen 31 towards the second position. In the embodiment shown, the resilient member is a helical spring 35 which, on the one hand, bears against a bearing surface of the insulating flap 26 and, on the other hand, bears against a bearing surface provided in the lid 30. In the embodiment shown, the indicator screen 31 has a centring pin 36 around which the helical spring 35 is threaded, which prevents the latter from becoming misaligned.

As shown in FIG. 11, the lid 30 has a window 37 which is unobstructed when the indicator screen 31 is in the first position but through which the indicator screen 31 is visible when it is in the second position. It is thus possible to detect from outside the housing 10 that the thermofusible connection 21 is in the disconnected state and the insulating flap 26 in the cut-off position.

Advantageously, as also shown in FIG. 10, the indicator screen 31 comprises a member 38 for receiving a tool which is arranged opposite an aperture 39 formed in the lid 30. The aperture 39 extends in the direction of movement of the indicator screen 31 between the first and second positions. This makes it possible, in particular, to arm the visual indication device from outside the housing 10 using a suitable tool, such as a blade or screwdriver for example, i.e. to move the indicator screen 31 towards the first position so that the locking hook 32 engages with the locking pin 33 of the insulating flap 26.

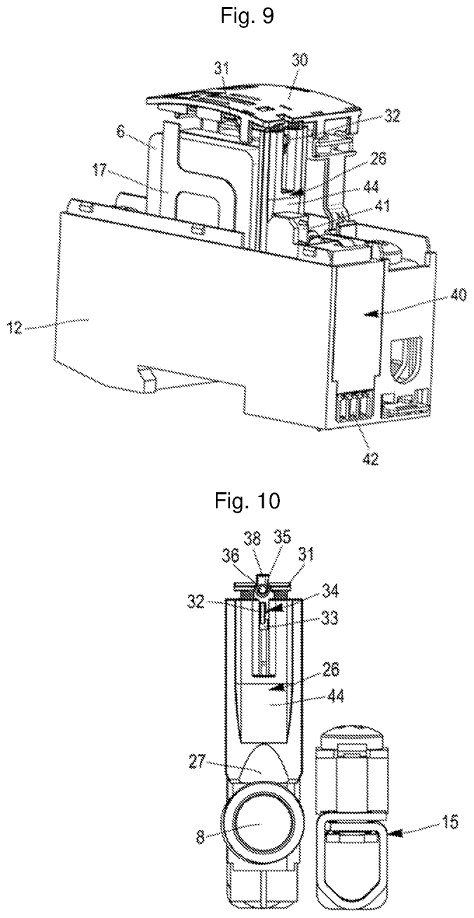

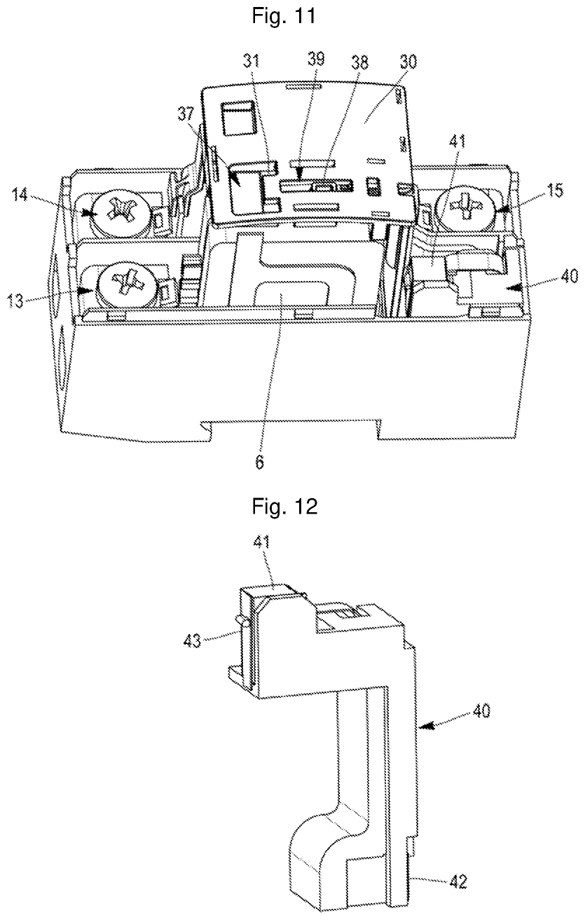

In addition, the protection device 1 also comprises a remote signalling module 40, visible in particular in FIGS. 9 and 12, which makes it possible to signal to a remote monitoring station that the thermofusible connection 21 is in the disconnected state and that, consequently, the protection device 1 must be replaced. The remote signalling module 40 comprises a switch 41 which is electrically connected to a connector 42 suitable and intended for connection to the remote monitoring station. The switch 41 has a blade 43, visible in FIG. 12, which is arranged opposite the insulating flap 26. In addition, the insulating flap 26 has an inclined face 44, visible in particular in FIG. 10, which is arranged opposite the blade 43 of the switch 41 in such a way that the blade 43 of the switch 41 moves from an open state to a closed state when the insulating flap 26 moves from the original position to the cut-off position.

Advantageously, the remote signalling module 40 is a pre-assembled module which can be accommodated in a dedicated housing provided in the base 11 of the housing 10. All the functions of the remote signalling module are thus pre-assembled, which facilitates manufacture and assembly of the protection device 1.

The main stages in the process of assembling the protection device 1 will now be described. Initially, a sub-assembly is produced, as shown in FIG. 3, comprising the components of the electrical circuit, i.e. the connection terminals 13, 14, 15, the varistors 6, 7, the gas discharge tubes 8, 9, the thermofusible connection 21, the connection piece 22 and the flexible braid 23. In this way, the thermofusible connection 21—which can be obtained in particular by soldering operations carried out at high temperatures—is produced before the electrical circuit is installed in the housing 10. This avoids subjecting the housing 10, which is generally made of plastic, to high temperatures.

The sub-assembly shown in FIG. 3 is then positioned in the base 12 of the housing 10. The pre-assembled remote signalling module 40 is also fitted in the dedicated housing in the base 11. The cover 11 can then be clipped to the base 12 of the housing 10. The arc-breaking device is mounted in the cover 11, and the lid 30, on which the visual indicator is mounted, is then clipped to the cover 11. The visual indication device is then fitted using a tool positioned in the member 38 by sliding the indicator screen 31 towards the first position until the hook 32 engages with the locking pin 33 of the insulating flap 26.

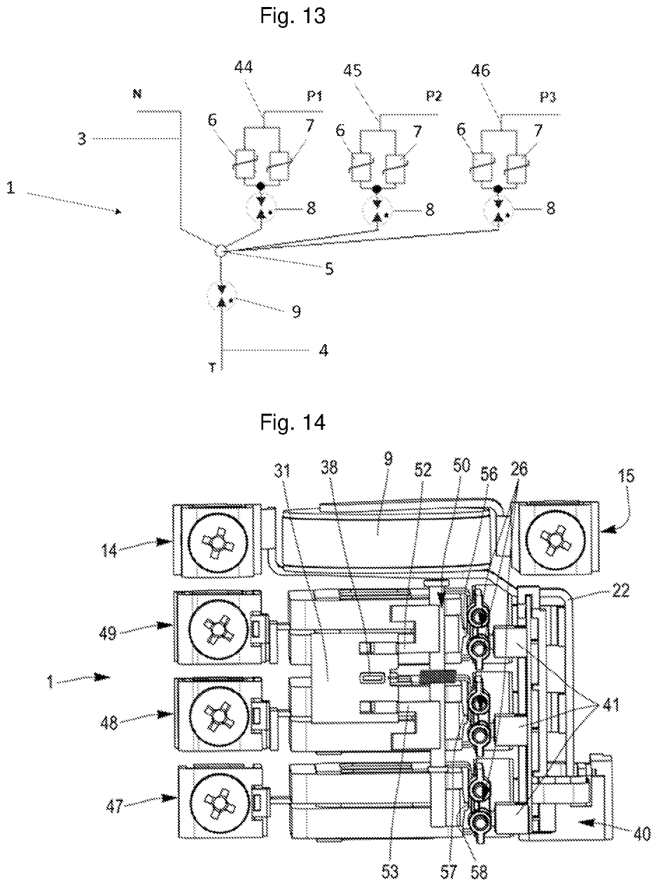

FIG. 13 is a schematic illustration of an electrical circuit of a surge protection device according to a second embodiment. In this embodiment, the surge protection device is intended to be installed in a three-phase electrical installation. In other words, the electrical installation comprises three phase lines P1, P2, P3, a neutral line N and an earth line T. In this embodiment, each of the three phase branches 44, 45, 46 has three protection elements, namely two varistors 6, 7 arranged in parallel and a gas discharge tube 8. As in the previous embodiment, the earth branch 4 only has a gas discharge tube 9, while the neutral branch 3 has no protection element.

FIGS. 14 to 16 show a protection device 1 according to an embodiment corresponding to the electrical diagram in FIG. 13.

The protection device 1 has five connection terminals, namely three connection terminals 47, 48, 49 which are each intended to be electrically connected to one of the phase lines, in addition to the two connection terminals 14, 15 which are respectively intended to be connected to the earth line and the neutral line.

Each of the three phase branches has a structure similar to that described in relation to the embodiment shown in FIGS. 2 to 12. In addition, the neutral and phase branches are identical to those in the first embodiment. However, in this embodiment, the flexible braid 23 of each of the three phase branches is connected to a single connection piece 22 which electrically connects the flexible braids 23, on the one hand, to an electrode of the gas discharge tube 9 of the earth branch 4, and, on the other hand, to the connection terminal 14 which is intended to be connected to the neutral line.

In addition, the protection device comprises three arc-breaking devices, each of which has a structure similar to that of the arc-breaking device previously described in relation to the embodiment of FIGS. 2 to 12, and each of which comprises an insulating flap 26 intended to be inserted between the varistors 6, 7 and the gas discharge tube 8 of one of the phase branches when the thermofusible connection 21 of said phase branch has melted.

In this embodiment, the protection device comprises only one pre-assembled remote signalling module 40. However, the remote signalling module 40 comprises three switches 41 which are connected to the connector 42 of said remote signalling module 40. The three switches 41 are each designed to be actuated when the insulating flap 26 of a respective arc-breaking device is moved.

In addition, in the embodiment shown, the protection device 1 has only one visual indication device. The visual indication device comprises an indicator screen 31 which is movable between a first position representative of an in-service state of the protection device 1 corresponding to an original position of the insulating flap 26 of the three arc-breaking devices and a connected state of the three thermofusible connections 21 and a second position representative of an out-of-service state of the protection device 15 corresponding to a cut-off position of the insulating flap 26 of at least one of the three arc-breaking devices and, consequently, to a disconnected state of at least one of the three thermofusible connections 21.

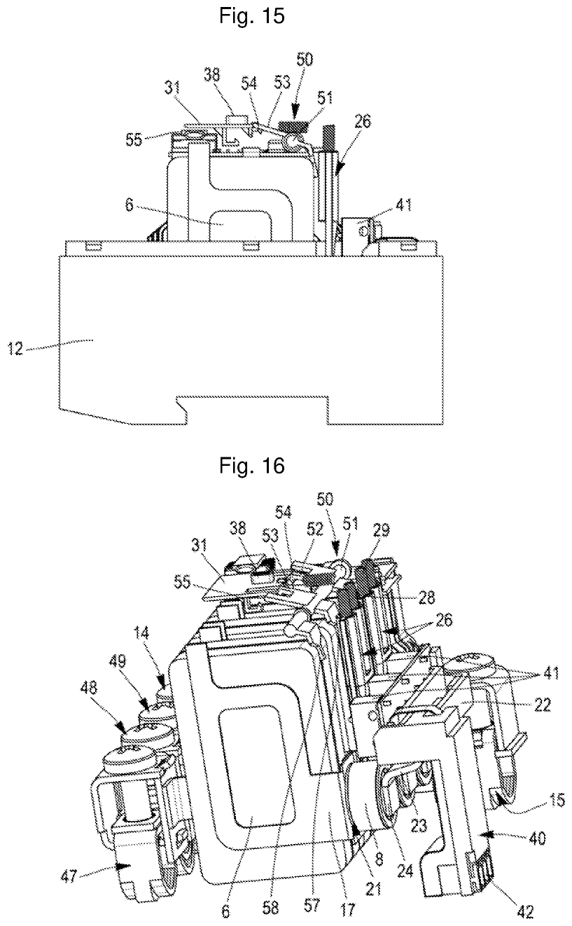

In order to allow the indicator screen 31 to move to the second position when one of the three insulating flaps 26 is in the off position, the visual indication device includes an unlocking device 50, which can be seen in FIGS. 15 and 16.

The unlocking device 50 comprises a shaft 51 pivotally mounted on the housing 10 and more particularly on its lid 30, between a locking position, not shown, and an unlocked position, shown in FIGS. 15 and 16. The shaft 51 carries two tongues 52, 53 which are each equipped with a locking hook 54 which is configured to cooperate with a complementary hook 55 on the indicator screen 31 when the shaft 50 is in the locking position and the indicator screen 31 is in the first position. Furthermore, the shaft 51 comprises three actuating fingers 56, 57, 58 which are each arranged to be moved by one of the insulating flaps 26 when the shaft 51 is in the locked position and said insulating flap 26 moves from the original position to the cut-off position in order to rotate the shaft 51 towards the unlocked position. To do this, according to one example, each of the actuating fingers 56, 57, 58 is arranged in the groove 34, below the locking pin 33, so that the locking pin 34 exerts a force on the actuating finger 56, 57, 58 when the insulating flap 26 moves towards the cut-off position. Consequently, when at least one of the insulating flaps 26 moves into the cut-off position, the shaft 51 is rotated towards the unlocked position, which releases the locking hooks 55 of the indicator screen 31. The latter can then move freely in the direction of the second position representing an out-of-service state of the protection device 1.

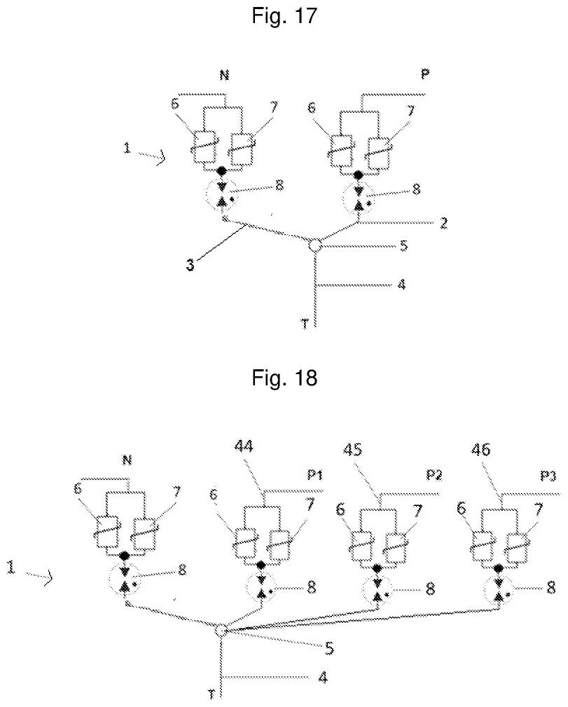

FIG. 17 is a schematic illustration of an electrical circuit of a surge protection device 1 according to a third embodiment. This embodiment differs from the embodiment shown in FIG. 1 only in that the earth branch 4 has no protection elements, whereas the neutral branch 3 has two varistors 6, 7 in parallel and arranged in series with a gas discharge tube 8 like the phase branch 2.

FIG. 18 is a schematic illustration of an electrical circuit of a surge protection device 1 according to a fourth embodiment, intended for a three-phase installation. This embodiment differs from the embodiment shown in FIG. 13 in that the earth branch 4 has no protection elements, while the neutral branch 3 has two varistors 6, 7 in parallel and arranged in series with a gas discharge tube 8 like the phase branch 2.

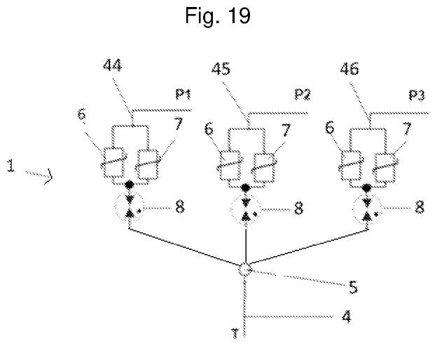

FIG. 19 is a schematic illustration of an electrical circuit of a surge protection device 1 according to a fifth embodiment, intended for a three-phase installation. In this embodiment, the protection device 1 differs from that shown in FIG. 13 in that it has no neutral branch and in that the earth branch 4 has no protection element.

Although the invention has been described in relation to several particular embodiments, it is clear that it is by no means limited thereto and that it includes all the technical equivalents of the means described as well as their combinations if these fall within the scope of the invention.

The use of the verb “comprise”, “have” or “include” and its conjugated forms does not exclude the presence of elements or steps other than those set out in a claim.

In the claims, any reference sign between parentheses should not be interpreted as a limitation of the claim.

What is claimed is:

1. A surge protection device (1) comprising:
at least a first connection terminal (13, 47) and a second connection terminal (14) which are respectively intended to be connected to a first line and to a second line of an electrical installation to be protected;
a first set of protection components comprising at least a first varistor (6) and a gas discharge tube (8), the first varistor (6) comprising a first varistor electrode (16) and a second varistor electrode (17), the first varistor electrode (16) being electrically connected to the first connection terminal (13, 47), the gas discharge tube (8) comprising a first discharge tube electrode and a second discharge tube electrode; the first discharge tube electrode being electrically connected to the second varistor electrode (17) by a thermofusible connection (21) which is capable of passing, when said thermofusible connection (21) is subjected to a temperature exceeding a threshold, from a connected state to a disconnected state in which the second varistor electrode (17) and the first discharge tube electrode are disconnected from each other;
at least a first arc-breaking device which comprises an insulating flap (26) which is configured to move, when the thermofusible connection (21) passes from the connected state to the disconnected state, from an original position to a cut-off position in which said insulating flap (26) is interposed between the second varistor electrode (17) and the first discharge tube electrode; and
said protection device (1) being characterized in that the first set of protection components comprises a flexible braid (23) which is welded to the second discharge tube electrode and is electrically connected to a connection piece (22), said connection piece (22) being electrically connected to the second connection terminal (14), said flexible braid (23) being able to deform so as to allow the gas discharge tube (8) to move away from the first varistor (6) and the insulating flap (26) to move into the cut-off position when the thermofusible connection (21) passes into the disconnected state.

2. The protection device (1) according to claim 1, wherein the flexible braid (23) has a cross-section of between 2 and 14 mm².

3. The protection device (1) according to claim 1, wherein the flexible braid (23) comprises a plurality of copper strands braided together.

4. The protection device (1) according to claim 1, wherein the first arc-breaking device comprises at least one resilient member (28, 29) which is arranged to bias the insulating flap (26) towards the cut-off position and which holds a first end of the insulating flap (26) in abutment against the gas discharge tube (8) when said insulating flap (26) is in the original position.

5. The protection device (1) according to claim 4, wherein at least part of the first end comprises a bevel (27) having a thickness which increases towards a second, opposite end of the insulating flap (26).

6. The protection device (1) according to claim 1, comprising a remote signalling module (40) which is pre-assembled and positioned in a dedicated housing, the remote signalling module (40) comprising a connector (42) suitable for and intended to be connected to a remote monitoring station and a switch (41) which is electrically connected to said connector (42), the switch (41) comprising a blade (43) which is arranged opposite the insulating flap (26) in such a way that the blade (43) of the switch (41) moves from an open state to a closed state when the insulating flap (26) moves from the original position to the cut-off position.

7. The protection device (1) according to claim 1, in which the first set of protection components additionally comprises a second varistor (7) which is arranged electrically in parallel with the first varistor (6) between the first connection terminal (13, 47) and the gas discharge tube (8), the second varistor (7) comprising a first varistor electrode (16) and a second varistor electrode (18), the first varistor (6) and the second varistor (7) being arranged against one another and in planes parallel to one another, the second varistor electrode (17) of the first varistor (6) and the second varistor electrode (18) of the second varistor (7) having bent portions (19,20) which extend perpendicularly to the planes of the first and second varistors (7), project towards one another and are soldered to one another in an overlap region.

8. The protection device (1) according to claim 7, wherein the first varistor electrode (16) of the first varistor (6) and the first varistor electrode (16) of the second varistor (7) are formed in one piece.

9. The protection device (1) according to claim 1, further comprising a visual indication device which includes an indicator screen (31) configured to take up a position representative of the position of the insulating flap (26) of the first arc-breaking device, said indicator screen (31) being movable between a first position representative of an in-service state of the protection device (1) corresponding to the original position of the insulating flap (26) and a second position representative of an out-of-service state of the protection device (1) corresponding to the cut-off position of the insulating flap (26).

10. The protection device (1) according to claim 9, wherein the indicator screen (31) is movable in translation in a direction which is perpendicular to a direction of movement of the insulating flap (26) between the original position and the cut-off position, the visual indication device comprising a resilient member (35) configured to bias the indicator screen (31) towards the second position, the indicator screen (31) comprising a locking member (32) arranged to cooperate with a complementary locking member (33, 54) which is kinematically connected to the insulating flap (26), when the indicator screen (31) is in the second position and the insulating flap (26) is in the original position, so that a movement of the insulating flap (26) from the original position towards the cut-off position causes a release of the locking member (32) and a movement of the indicator screen (31) towards the second position.

11. The protection device (1) according to claim 10, comprising a housing (10) comprising a base (11) and a cover (12) defining between them an internal space in which are housed the first connection terminal (13, 47), the second connection terminal (14), the first varistor (6), the gas discharge tube (8), the thermofusible connection (21), the flexible braid (23), the connection piece (22) and the first arc-breaking device, the cover (12) comprising a lid (30) which is removable, the indicator screen (31) being mounted movably in translation on said lid (30).

12. The protection device (1) according to claim 11, wherein the cover (30) comprises a window (37) through which the indicator screen (31) is visible when said indicator screen (31) is in the second position.

13. The protection device (1) according to claim 11, in which the indicator screen (31) comprises a member (38) which is suitable and intended for receiving a tool and which is arranged opposite an aperture (39) which is formed in the cover (30) and which extends parallel to the direction of movement of the indicator screen (31).

14. The protection device (1) according to claim 1, comprising a third connection terminal (48) and a second set of protection components comprising at least one varistor (6) and a gas discharge tube (8) which are arranged in series between the third connection terminal (48) and the connection piece (22) and are connected to each other by a second thermofusible connection (21), the protection device (1) further comprising a second arc-breaking device which includes an insulating flap (26) which is configured to move, when the second thermofusible connection (21) passes from a connected state to a disconnected state, from an original position to a cut-off position in which said insulating flap (26) is interposed between the varistor (6) and the gas discharge tube (8) of the second set of protection components.

15. The protection device (1) according to claim 14, further comprising a visual indication device which includes an indicator screen (31), said indicator screen (31) being movable between a first position representative of an in-service state of the protection device (1) corresponding to the original position of the insulating flap (26) of the first and second arc-breaking devices and a second position representative of an out-of-service state of the protection device (1) corresponding to the cut-off position of the insulating flap (26) of at least one of the first and second arc-breaking devices.

16. The protection device (1) according to claim 15, in which the indicator screen (31) can be moved in translation in a second direction, perpendicular to the directions of movement of the insulating flap (26) of the first and second arc-breaking devices between the original position and the cut-off position, the visual indication device comprising a resilient member (35) configured to bias the indicator screen (31) towards the second position, the indicator screen (31) comprising a locking member (55) arranged to cooperate with a complementary locking member (54) of a locking device when the indicator screen (31) is in the second position and said locking device is in a locking position, said locking device being movable between the locking position and an unlocked position and being kinematically connected to the insulating flaps (26) of the first and second arc-breaking devices so that a movement of the insulating flap (26) of at least one of the first and second arc-breaking devices towards the cut-off position causes a movement of the locking device towards the unlocked position and, consequently, a release of the locking member (55) and a movement of the indicator screen (31) towards the second position.

17. The protection device (1) according to claim 16, in which the locking device comprises a shaft (51) which carries the complementary locking member (54) and which is mounted so as to pivot between a locked position and an unlocked position, the shaft (51) comprising at least two actuating fingers (56, 57, 58) which are respectively arranged to be moved by the insulating flap (26) of one and the other of the first and second arc-breaking devices when the shaft (51) is in the locking position and said insulating flap (26) moves from the original position towards the cut-off position in order to rotate the shaft (51) towards the unlocked position.

18. A method for assembling a protection device (1) comprising:
making a first sub-assembly comprising:
at least a first connection terminal (13, 47) and a second connection terminal (14) which are respectively intended to be connected to a first line and a second line of an electrical installation to be protected;
a first set of protection components comprising at least a first varistor (6) and a gas discharge tube (8), the first varistor (6) comprising a first varistor electrode (16) and a second varistor electrode (17), the first varistor electrode (16) being electrically connected to the first connection terminal (13, 47), the gas discharge tube (8) comprising a first discharge tube electrode and a second discharge tube electrode; the first discharge tube electrode being electrically connected to the second varistor electrode (17) by a thermofusible connection (21) which is capable of passing, when said thermofusible connection (21) is subjected to a temperature exceeding a threshold, from a connected state to a disconnected state in which the second varistor electrode (17) and the first discharge tube electrode are disconnected from each other; the first set of protection components comprising a flexible braid (23) which is soldered to the second discharge tube electrode and electrically connected to a connection piece (22), said connection piece (22) being electrically connected to the second connection terminal (14), said flexible braid (23) being able to deform so as to allow the gas discharge tube (8) to move away from the first varistor (6) and the insulating flap (26) to move into the cut-off position when the thermofusible connection (21) passes into the disconnected state;
mounting the first sub-assembly in a base (11) of a housing (10);
mounting a first arc-breaking device in the housing (10), the first arc-breaking device comprising an insulating flap (26) which is configured to move, upon a transition of the thermofusible connection (21) from the connected state to the disconnected state, from an original position to a cut-off position in which said insulating flap (26) is interposed between the second varistor electrode (17) and the first discharge tube electrode; and
closing the housing (10) by securing the base (11) to a cover (12) of the housing (10).
